(19) United States
(12) Patent Application Publication
(10) Pub. No.: US 2026/0154584 A1
(43) Pub. Date: Jun. 4, 2026

(54) DISTRIBUTED SIMULATION OF QUANTUM SYSTEMS WITH OPTIMIZED TENSOR MODE REDISTRIBUTION

(71) Applicant: NViDIA Corporation, Santa Clara, CA (US)

(72) Inventors: Dmytro LIAKH, Knoxville, TN (US); Benedikt KLOSS, Brooklyn, NY (US)

(21) Appl. No.: 18/948,394

(22) Filed: Nov. 14, 2024

(51) Int. Cl. G06N 10/20

(52) U.S. Cl. CPC G06N 10/20

(57) ABSTRACT

In various embodiments, systems and methods for distributed simulation of time dynamics of quantum systems with an optimized tensor mode redistribution schedule are provided. A scheduling optimizer may create a schedule of tensor redistributions based on a hypergraph constructed from a quantum many-body operator. The scheduling optimizer iteratively distributes a quantum state tensor into state tensor slices based on a clustering process that partitions the hypergraph into clusters, and redistributes the quantum state tensor across processing units based on identified sliced or non-sliced tensor modes according to the obtained clusters. Operators that can be applied to non-sliced modes of the redistributed quantum state tensor are applied, and the iterative process repeats until each of the operators of the full quantum many-body operator have been applied. Because these operators act on non-sliced modes, inter-processing unit communication is minimized while executing these operations, and tensor redistributions across all processing units is minimized.

### BACKGROUND

The simulation of time dynamics of quantum systems on classical computing processors (e.g., central processing units (CPUs) and/or graphics processing units (GPUs)) can be achieved by simulating the action of a quantum many-body operator on a quantum state tensor. Typically, a quantum system can include multiple elements where each element defines a quantum degree of freedom, often referred to as a mode of the quantum system. Each element of a quantum system may be described by an individual vector space, such that the space that comprises the state of the full quantum system may be represented as a tensor product space. That tensor product space includes all of the individual vector spaces (e.g., a quantum system comprising five quantum elements interacting with each other is described by a tensor product of the five corresponding individual vector spaces) so that a state of the full quantum system may therefore be expressed in the tensor product space. A quantum many-body operator comprises different operators that describe interactions between the different elements of the quantum system. The quantum many-body operator is typically constructed as a sum of tensor products of the elementary operators that define the full quantum many-body operator of the quantum system under consideration.

### SUMMARY

Embodiments of the present disclosure relate to simulation of time dynamics of quantum systems with tensor mode redistribution schedule optimization. Systems and methods are disclosed that provide a fast quantum many-body operator action algorithm that enables efficient execution across many computing units (e.g., processing units, CPUs, GPUs, etc.) via explicit exploitation of the structure of a given quantum many-body operator, combined with efficient scalable tensor redistribution procedures.

In contrast to prior existing quantum system simulators, embodiments of the present disclosure provide a fast quantum many-body operator action algorithm, which enables efficient execution across processing units of a simulation platform, via explicit exploitation of the structure of a given quantum many-body operator, combined with efficient scalable tensor redistribution procedures. These techniques involve the scheduling of global tensor redistributions in an optimized manner to allow for an optimized simulation of general quantum systems while also minimizing the data communication volume between processing units. In some embodiments, a scheduling optimizer creates a schedule for performing a minimal number of global tensor redistributions to perform the quantum system simulation, and thus significantly reduces the data communication volume and, as a consequence, improves performance that allows for faster and/or larger quantum system simulations by a simulation platform.

The scheduling optimizer may create a schedule of a minimal number of tensor redistributions based on a hypergraph constructed from the quantum many-body operator. The scheduling optimizer at each iteration identifies operator terms of the quantum many-body operator that can be applied without operating on a discrete collection (e.g., “slice”) of modes of the quantum state tensor, and applies those operators. Such operations that only affect tensor modes that are not included in a discrete collection (“non-sliced”) can be applied without incurring inter-processor communication costs. For those remaining operations, a global tensor redistribution is performed in which different modes of the quantum state tensor are permuted, sliced (re-allocated in another collection of modes), and distributed across the processing units. The remaining operators that can be applied to non-sliced modes of the redistributed quantum state tensor (without communication) are applied, and the iterative process repeats until each of the operators of the full quantum many-body operator have been applied. The hypergraph constructed from the quantum many-body operator provides the framework used by the scheduling optimizer to identify which combination of the many possible sequences of tensor redistributions provides a solution in a minimal number of such tensor data redistributions across processing units. The scheduling optimizer then proceeds with a clustering process to partition the hypergraph into two partitions where, for the current global tensor distribution, a first partition identifies modes that will be distributed across the processing units as sliced modes, and a second partition identifies modes that will be shared across the processing units as whole modes. In some embodiments, the scheduling optimizer performs the clustering by performing a minimum-cut graph algorithm. The scheduling optimizer permutes and redistributes the quantum state tensor based on the identified sliced or non-sliced tensor modes according to the obtained partitioning, and then the simulation platform applies elementary operators of the quantum many-body operator acting on the modes that are not sliced without any inter-processor communication. Because this set of elementary operators acts on non-sliced modes, communication between processing units is not needed to fully compute these operations.

### BRIEF DESCRIPTION OF THE DRAWINGS

The present systems and methods for simulation of time dynamics of quantum systems with tensor mode redistribution schedule optimization are described in detail below with reference to the attached drawing figures, wherein:

FIG. 1 is an illustration of an example flow diagram for a quantum simulation environment using an optimized tensor mode redistribution schedule, in accordance with some embodiments of the present disclosure;

FIG. 2 is a data flow diagram illustrating an example iterative quantum state tensor redistribution process performed by a scheduling optimizer, in accordance with some embodiments of the present disclosure;

FIGS. 3A-3H are diagrams illustrating an iterative distributed quantum system simulation process, in accordance with some embodiments of the present disclosure;

FIG. 4 is a diagram illustrating a method for simulating a quantum system using an optimized tensor mode redistribution schedule, in accordance with some embodiments of the present disclosure;

FIG. 5 is a block diagram of an example computing device suitable for use in implementing some embodiments of the present disclosure; and

FIG. 6 is a block diagram of an example data center suitable for use in implementing some embodiments of the present disclosure.

### DETAILED DESCRIPTION

Systems and methods are disclosed related to simulation of time dynamics of quantum systems with tensor mode redistribution schedule optimization.

The simulation of time dynamics of a quantum system interacting with electro-magnetic fields and a surrounding physical environment is described by ordinary differential equations (ODE) called quantum master equations. That is, a simulation of quantum time dynamics is a simulation of a quantum system that describes how the quantum system evolves in time under the influence of interactions with fields and a physical environment. In many scientific domains, master equations are used to describe the time evolution of a system that can be modeled as being in a probabilistic combination of states at any given time. A quantum master equation is a generalized master equation that includes differential equations for an entire density matrix of the quantum system, including diagonal and off-diagonal elements. While diagonal elements can be modeled as a classical random process, off-diagonal elements represent quantum coherence-intrinsically quantum mechanical characteristics that may be used to express the potential for two waves to interfere.

The evolution in time of a quantum state for a quantum system may be determined by a quantum Liouvillian operator, which is specific to the quantum system being described, where the quantum state itself is described by a tensor belonging to a tensor product space consisting of one or more quantum degrees of freedom. Tensor objects (which may be referred to simply as “tensors”) are a generalization of scalars (0 dimensions), vectors (1 dimension), and matrices (2 dimensions) to any arbitrary number of dimensions. The object of such a quantum state simulation is to determine how the quantum system evolves from the initial state to some final state under the action of this quantum Liouvillian operator. A quantum Liouvillian operator is a quantum many-body operator that comprises different terms, such as but not limited to, the system Hamiltonian operator, the electro-magnetic interaction Hamiltonian operator, and/or the system-environment interaction operators (dissipation terms). Further, each term of a quantum Liouvillian operator is typically a quantum many-body operator itself. That is, each term can be expressed as a sum of tensor products of elementary operators, where each elementary operator acts linearly on a single, or on multiple, quantum degree(s) of freedom.

Simulation of time dynamics of a given quantum system on a classical computer involves computing the action of a quantum many-body operator (e.g., a quantum Liouvillian operator) on the quantum state tensor representing the quantum state of the given quantum system. Computing the action of a quantum many-body operator on the quantum state is the most computationally expensive step executed by a quantum dynamics simulator. That said, there is a lack of techniques that may be used by a quantum system simulator to optimize these computations. For example, existing quantum system simulators are unable to scale in their ability to apply a quantum many-body operator on the quantum state because they are unable to fully exploit a sparse many-body structure of a given quantum many-body operator. Moreover, although computations may be distributed across multiple processes, doing so introduces cross-processor communication tasks that, for anything beyond a trivial quantum system, quickly consume excess computing platform resources (e.g., processing time and/or memory) greater than the actual quantum operation calculation. Specifically, when a quantum state tensor is sliced over specific tensor modes, the obtained tensor slices may be distributed across a set of processor units, such as graphical processing units (GPUs), where each processing unit stores and applies operators for one tensor slice. For example, for a quantum system comprising five quantum elements (e.g., five neutral atoms), the full state of the composite quantum system may be represented by a tensor comprising five degrees of freedom, where each degree of freedom defines a tensor mode. Assuming, for example, that each tensor mode comprises ten energy levels, then the total size of the full pure quantum state tensor will be 10\hat{ }5, or 100,000 energy levels. For the corresponding mixed state of the same quantum system, the total size of the quantum state tensor (density matrix) will be (10\hat{ }5)\hat{ }2, or 10 billion. This size equates to approximately 160 gigabytes of data for storage in a standard GPU memory. As such, as the number of quantum elements in a given quantum system increases, the size of the full quantum state tensor grows exponentially, and at some point will grow beyond the memory capacity of a single GPU. As an example, a quantum system comprising up to 30 to 40 quantum elements would not be unexpected to perform a practical quantum system simulation—and some practical quantum elements, such as a resonator element, may comprise modes having hundreds of energy levels.

If, for example, a first mode of the quantum state tensor is sliced into two segments (e.g., one has five energy levels and the other segment has five energy levels as well) and distributed across two processing units, then the size of the sliced quantum state tensor component processed by any one of the processing units may be considerably reduced as compared to the total size of the full quantum state tensor. Further reductions can be achieved by slicing additional modes and/or distributing them across a greater number of processing units. However, quantum many-body operator terms acting on the sliced tensor modes require data communication between several processing units (e.g., GPUs), which hinders the simulator performance (e.g., the parallel efficiency drops). For general quantum systems, existing simulators communicate data as needed when applying different terms from the quantum many-body operator, which is suboptimal and inefficient, especially when the full quantum many-body operator is represented as a gigantic matrix. While optimization algorithms exist for quantum systems composed of qubits and/or for spin-1/2 quantum systems, those optimizations are based on a global tensor redistribution that does not apply to general quantum systems. Furthermore, the existing optimization procedures do not prescribe the minimal number of necessary tensor redistributions for a general quantum many-body operator, thus they do not ensure the minimal inter-process communication volume.

As described herein, in contrast to prior existing quantum system simulators, embodiments of the present disclosure provide a fast quantum many-body operator action algorithm which enables efficient execution on a single computing unit (e.g., GPU) as well as across many computing units (e.g., GPUs) via explicit exploitation of the structure of a given quantum many-body operator, combined with efficient scalable tensor redistribution procedures. These techniques involve the scheduling of global tensor redistributions in an optimized manner to allow for an optimized simulation of general quantum systems without restriction to just quantum circuits (e.g., qubit) and/or spin-1/2 quantum systems, while also minimizing the data communication volume between processing units. In some embodiments, a scheduling optimizer creates a schedule for performing a minimal number of global tensor redistributions to perform the quantum system simulation, and thus significantly reduces the data communication volume and, as a consequence, improves performance that allows for faster and/or larger quantum system simulations by a simulation platform.

In some embodiments, a scheduling optimizer for a multi-processing unit simulation platform creates a schedule of a minimal number of tensor redistributions based on a hypergraph constructed from the quantum many-body operator. In an iterative process explained in greater detail below, the scheduling optimizer at each iteration identifies operator terms of the quantum many-body operator that can be applied without operating on sliced modes of the quantum state tensor, and applies those operators. Such operations that only affect non-sliced tensor modes can be applied without incurring inter-processor communication costs. For those remaining operations, a global tensor redistribution is performed in which different modes of the quantum state tensor are permuted, sliced, and distributed across the processing units. The remaining operators that can be applied to non-sliced modes of the redistributed quantum state tensor (without communication) are applied, and the iterative process repeats until each of the operators of the full quantum many-body operator has been applied.

As explained in greater detail herein, the hypergraph constructed from the quantum many-body operator provides the framework used by the scheduling optimizer to identify which combination of the many possible sequences of tensor redistributions provides a solution in a minimal number of such tensor data redistributions across processing units. In some embodiments, the scheduling optimizer using the hypergraph-based procedure described herein can, for a general quantum many-body operator consisting of at most k-local elementary operators and a quantum state tensor having more than k modes, achieve a minimal number of k+1 redistribution iterations. This process further results in approximately 2*S*(k+1) total words of data communicated by all P processing units performing the simulation, which is superior to approximately S*P total words of data that need to be communicated by all P GPUs without exploiting the structure of the given quantum many-body operator (where S is the size of the quantum state tensor). For a quantum many-body operator constructed from the typical one- and two-local operators of interest used to perform practical quantum dynamics simulations (e.g., Pauli operators and/or second-quantized creator/annihilator operators), the scheduling optimizer applying the fast quantum many-body operator action algorithm may achieve a factor of P/(k+1)/2 advantage in the total communication volume, where P can be as large as O(10K) on modern high-performance computing (HPC) platforms whereas a typical k is equal to 2 or 3. For the case where the quantum state tensor undergoing global storage redistribution has at least some modes not sliced in both the input and output storage layouts, the execution of the scheduling optimizer may reduce the memory overhead of an out-of-place redistribution procedure by approximately a factor of M, where M is the total combined dimension of those joint unsliced modes. Since M can easily exceed 10, the scheduling optimizer may obtain a simulation solution result that uses less than 10% processing unit memory overhead for many practical cases.

As previously mentioned, the scheduling optimizer may create a schedule of a minimal number of tensor redistributions based on constructing a hypergraph from the quantum many-body operator. Whereas an edge in a standard graph connects two vertices, a hypergraph may comprise hyperedges that connect any number of vertices. In some embodiments, the scheduling optimizer may define a hypergraph, wherein each of the vertices of the hypergraph corresponds to a mode of the quantum state tensor. For example, if the quantum state tensor comprises five modes, then the scheduling optimizer may define a hypergraph comprising five vertices where each of the vertices represents one of the five modes. The scheduling optimizer may sequence through each individual operator or operator product of the quantum many-body operator to identify which modes of the quantum state tensor are acted on by that operator or operator product. For example, if a first operator acts on modes 1 and 3 of the quantum state tensor, then the scheduling optimizer adds a hyperedge to vertices 1 and 3 of the hypergraph. If a second operator (or operator product) acts on modes 2, 3, and 4 of the quantum state tensor, then the scheduling optimizer adds a hyperedge to vertices 2, 3, and 4 of the hypergraph. The scheduling optimizer sequences through the operator products of the quantum many-body operator until all corresponding hyperedges are added to the vertices of the hypergraph for each operator or operator product constituting the quantum many-body operator.

The scheduling optimizer then proceeds with a clustering process to partition the hypergraph into two partitions where, for the current global tensor distribution, a first partition identifies modes that will be distributed across the processing units as sliced modes, and a second partition identifies modes that will be shared across the processing units as whole modes. In some embodiments, the scheduling optimizer performs the clustering by performing a minimum-cut graph algorithm. In graph theory, a minimum cut (or min-cut) of a graph is a cut of the vertices of the hypergraph into two disjoint subsets that are based on minimization of a metric obtained from the hyperedges connecting the two subsets. Here, the scheduling optimizer may apply a constraint specifying that the smaller cluster must include at least a minimum number of modes that are sufficient to decompose the tensor across all processing units, and specifying that the number of connections (e.g., the number of hyperedges) connecting the two clusters is minimized. Based on the minimum cut, one cluster corresponds to vertices for modes that need to be sliced, and the other cluster of vertices corresponds to the vertices for modes that do not need to be sliced. The scheduling optimizer permutes and redistributes the quantum state tensor based on the identified sliced or non-sliced tensor modes according to the obtained partitioning, and then the simulation platform applies elementary operators of the quantum many-body operator acting on the modes that are not sliced without any inter-processor communication. Because this set of elementary operators acts on non-sliced modes, communication between processing units is not needed to fully compute these operations. As described below, at each iteration the global tensor redistribution performed by the scheduling optimizer may select between performing the redistribution as an “out-of-place” tensor redistribution or as an “almost-in-place” tensor redistribution (e.g., based at least on available processing resources).

After application of the elementary operators of the quantum many-body operator that act on the non-sliced modes, hyperedges corresponding to the applied elementary operators are removed from the hypergraph to produce a reduced hypergraph comprising those elementary operators that are yet to have acted on the quantum state tensor. This reduced hypergraph then operates as the seed hypergraph for performing the next iteration of clustering, permuting, quantum state tensor redistribution, and application of elementary operators as just described—where after each iteration the hypergraph is further reduced in size as hyperedges for already applied elementary operators are removed. The process may thus continue until all elementary operators of the quantum many-body operator have acted on the quantum state tensor. As previously discussed, the scheduling optimizer is expected to complete the process to apply all elementary operators of the quantum many-body operator within k+1 tensor redistribution iterations, but in some cases scheduling optimizer will complete the procedure in a fewer number of iterations. After the last iteration of redistributions and application of elementary operators to the quantum state tensor, the resulting quantum state tensor (with the quantum many-body operator fully applied) will return back to the original distribution layout of the initial quantum state tensor to produce a quantum system simulation result from the quantum simulation platform.

As previously discussed, at each iteration the scheduling optimizer may select between performing the redistribution as an “out-of-place” tensor redistribution or as an “almost-in-place” tensor redistribution. Each tensor redistribution performed by the scheduling optimizer represents a change in the layout of the modes of the quantum state tensor and a reconfiguration of how the quantum state tensor is sliced and distributed across the processing units performing the simulation. In essence, for each iteration, tensor redistribution takes an initial quantum state tensor distribution and slicing pattern, and maps the modes to a target quantum state tensor distribution and slicing pattern determined from the results of hypergraph clustering. Furthermore, in order to perform a tensor redistribution from this original slicing to the target slicing, each processing unit may need to communicate with each other processing unit to exchange quantum state tensor data before proceeding to the next step of applying elementary operators to the non-sliced modes.

To perform an out-of-place tensor redistribution, generally each processing unit communicates with each other processing unit by duplicating their respective sliced version of the quantum state tensor to a memory of the quantum simulation platform, which is then moved by the quantum simulation platform to the memory of the destination processing unit. As such, the quantum simulation platform needs to maintain a “workspace” buffer memory to perform the transfer that is of at least the same total size as the quantum state tensor, and perform memory write and read operations of that data a multiple number of times that is a function of the number of processing units that need to exchange sliced quantum state tensors with other processing units. For an input tensor sliced into P slices across P processing units, mapped to a target tensor sliced into P slices over a different subset of tensor modes across the P processing units, the loop over all unique pairs of processing units may be expressed as P*(P+1)/2 pairs of processing units that exchange data. Each processing unit from each pair identifies a sub-slice of its stored tensor slice that needs to be sent to its peer processing unit. Each processing unit from each pair extracts a corresponding sub-slice from its stored tensor slice and sends it over to its peer processing unit. Each processing unit from each pair receives the required sub-slice from its peer GPU and inserts it into its stored tensor slice. Each processor unit communicates 2*2*S/P words of data such that all processing units communicate 4*S/P*P=4*S words of data, where S is the quantum state tensor size. The resulting processing unit memory overhead may be expressed as S words, which in some instances may represent slightly more than 100% of the processing unit memory. As such, depending on the size of the quantum system being simulated and the number of processing units over which the simulation is distributed, an out-of-place tensor redistribution may introduce a substantial amount of memory resource overhead.

In contrast, if the union of sliced tensor modes in both the source and target quantum state tensor distributions does not cover all tensor modes, a more memory-efficient tensor redistribution may be archived by executing the “almost-in-place” distributed tensor redistribution embodiments described herein. Using “almost-in-place” distributed tensor redistribution, in some embodiments, the schedule optimizer can perform a tensor redistribution that uses just a fraction of the workspace memory that would otherwise be needed to perform an out-of-place tensor redistribution.

For example, to configure an optimal tensor redistribution (e.g., to avoid a purely out-of-place tensor redistribution) the scheduling optimizer may—based on the source tensor redistribution pattern and the target tensor redistribution pattern determined from clustering the hypergraph—identify one or more modes that are unsliced modes in both the source and target tensor redistribution patterns. These modes represent a set of modes that do not need to communicate to fully apply elementary operators because each processing unit already possesses a full representation of those non-sliced modes. That said, to perform the inter-processor communication used to fully compute application of the elementary operators to sliced modes, in-place matrix transpositions may be used to provisionally reorder both the source and target tensor redistribution patterns. A sequenced smaller out-of-place tensor redistribution may then be performed that is constrained by the newly sliced-modes. Using an in-place matrix transposition, the tensor may be recast into a matrix form and a mode reordering matrix transpose can be applied, and the resulting matrix recast back into a tensor form. In some embodiments, the provisional reordering obtained by the in-place matrix transposition may permute the non-sliced modes to the most senior positions inside the tensors, and then perform a memory segmentation of those tensor modes. In other words, in contrast to slicing a mode into segments based on the number of processing units being used, the memory segmentation divides modes based on a desired memory criteria (e.g., based on a size of a memory buffer available to perform the inter-processing unit communication). As such, instead of performing one (memory-intensive) out-of-place tensor redistribution of a full tensor, the inter-processing unit communication may be performed in a sequential manner by sequentially transferring smaller memory segments and thus reducing the overall amount of workspace memory required to perform the tensor redistribution.

In some embodiments, an almost-in-place tensor redistribution may be implemented using an algorithm. For a source tensor sliced into P slices across P processing units, mapped to a target tensor sliced into P slices over a different subset of tensor modes across the P processing units, a minimal workspace memory size may be computed based on the expression

$$\frac{1}{K} \times \frac{S}{P} ,$$

where K is the product of extents of a subset of those tensor modes that are not sliced in both the source and target tensors, and where S is the total size of the tensor. The tensor modes may be divided into three subsets (comprising adjacent modes when possible) that include: Subset 1, comprising sliced modes of the source tensor; Subset 2, comprising sliced modes of the target tensor; and Subset 3, comprising the remaining (non-sliced) modes. In some embodiments, padding of the source and target tensors may be used to satisfy the constraint that sliced modes are sliced into segments of the same size. An in-place matrix transposition (as described above) may be performed to move Subset 3 to the most significant (senior) position of the quantum state tensor, and Subset 3 fully sliced into K sub-slices. The scheduling optimizer may loop for K iterations, where in each iteration an out-of-place tensor redistribution of a sub-slice is performed by moving its data from its original storage (e.g., the memory storing the source tensor) into the workspace memory. The scheduling optimizer may then copy that data from the workspace memory into the corresponding target tensor sub-slice. Another in-place matrix transposition may be performed to restore the target tensor to its original order of tensor modes.

In some embodiments, an out-of-place tensor storage redistribution procedure may be the default process used by the scheduling optimizer to perform inter-processing unit data communication. In some embodiments, the scheduling optimizer may dynamically select between an out-of-place tensor storage redistribution procedure and an almost-in-place tensor storage redistribution procedure to perform inter-processing unit data communication based on available processing resources. For example, in some cases, to execute a given quantum system simulation the simulation platform may have ample processing power (e.g., number of processing units) and/or memory such that full tensor out-of-place tensor storage redistribution can be performed without taxing the simulation platform, which means each inter-processing unit data transfer can be performed as a single transfer operation using the available workspace memory. In contrast, where the computing resources of the simulation platform are more limited, then an almost-in-place tensor storage redistribution procedure that dynamically self-adjusts based on the available workspace memory may be selected by the scheduling optimizer. In some embodiments, the scheduling optimizer may dynamically select between an out-of-place tensor storage redistribution procedure and an almost-in-place tensor storage redistribution procedure to perform inter-processing unit data communication for each iteration of hypergraph processing performed by the scheduling optimizer (e.g., based on the amount of system memory available to implement the workspace memory for that iteration.

In various implementations, a quantum simulation platform comprising the scheduling optimizer, or otherwise implementing the scheduling optimization described herein, may be used to solve and/or simulate a broad range of complex quantum algorithms by simulating the action of a quantum many-body operator onto a quantum state tensor. In some embodiments, the scheduling optimization may be used to simulate time dynamics of quantum computing processors, quantum sensors, quantum materials, and/or other quantum systems, which may be interacting with electro-magnetic fields and a surrounding physical environment.

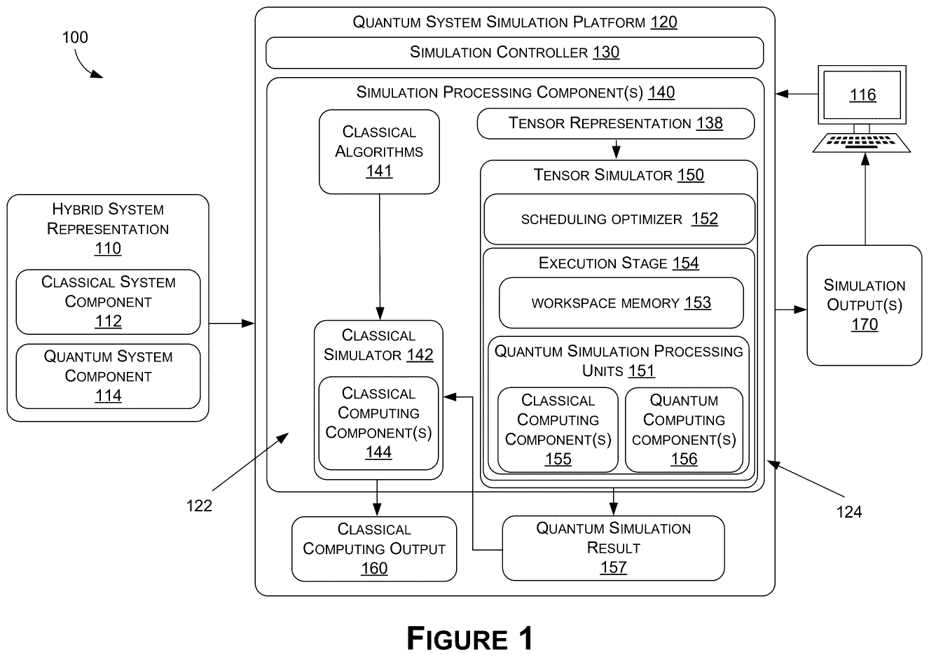

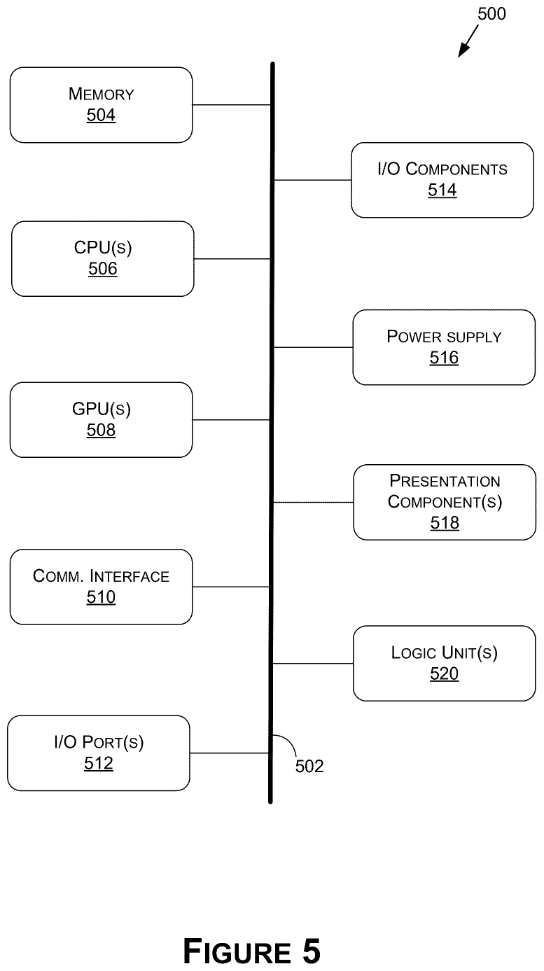

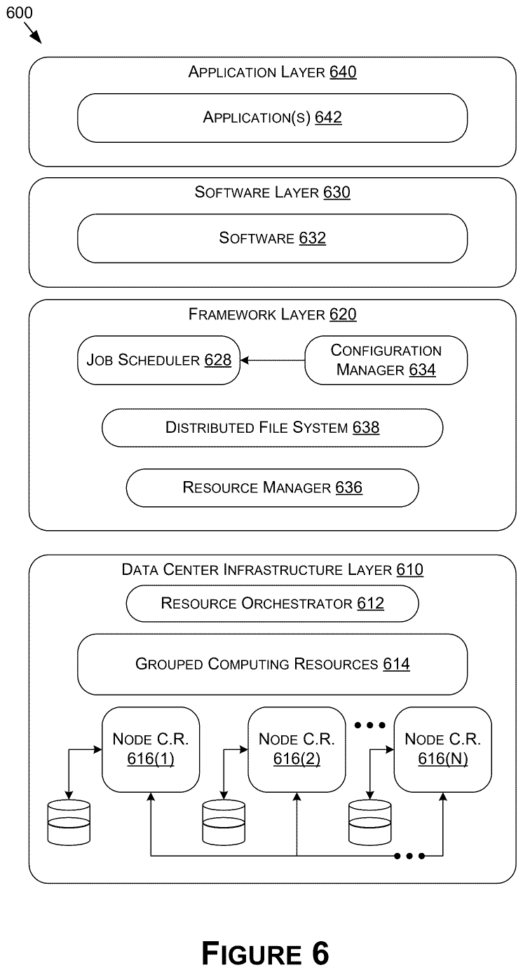

With reference to FIG. 1, FIG. 1 is an example data flow diagram of a process for a simulating a quantum environment 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by one or more processors comprising circuitry and executing instructions stored in memory. In some embodiments, the systems, methods, and processes described herein may be executed using similar components, features, and/or functionality to those of example computing device 500 of FIG. 5, and/or example data center 600 of FIG. 6.

The quantum simulation environment 100 may generate and/or receive a hybrid system representation 110 using a quantum system simulation platform 120. The hybrid system representation 110 may include at least one quantum system component 114 (e.g., that represents a quantum system). In some embodiments, such as the embodiment shown in FIG. 1, the hybrid system representation 110 may include a classical system component 112 (e.g., software code for execution on a non-quantum processor such as a central processing unit (CPU), a graphics processing unit (GPU), or other processing unit (e.g., a data processing unit (DPU)) or hardware accelerator). In this context, the hybrid system representation 110 may be referred to as a hybrid algorithm in that the hybrid system representation 110 may include a quantum system component 114 or a combination of a classical system component 112 with a quantum system component 114. In some embodiments, the hybrid system representation 110 may at least in part comprise hardware description language (HDL) code that describes the structure and/or behavior of a system (either classical, quantum, or a combination thereof) to be simulated by the quantum system simulation platform 120.

As shown in FIG. 1, the quantum system simulation platform 120 comprises a simulation controller 130 (e.g., software executed on platform 120 to initiate and control the execution of simulations based on the hybrid system representation 110) and one or more simulation processing components 140 (which are the underlying processing units—CPUs, GPUS, quantum processing units (QPUs), etc.—that execute the simulation based on the hybrid system representation 110).

In some embodiments, a user device 116 comprising a human-machine interface (HMI) may be coupled to the quantum system simulation platform 120 to interface with the simulation controller 130 to control and/or monitor one or more aspects of a simulation. In some embodiments, the quantum system simulation platform 120 may generate one or more simulation outputs 170 for display at the user device 116 based on the hybrid system representation 110, and/or for use as input to other systems. In some embodiments, the user device 116 may comprise a network node coupled to the quantum system simulation platform 120 via one or more networks, such as but not limited to those described herein. Moreover, the quantum system simulation platform 120 may, at least in part, be hosted using one or more cloud-based platforms and may communicate over one or more networks, such as but not limited to those described herein.

In some embodiments, the quantum system simulation platform 120 may generate a global simulation that simulates a virtual world or environment (e.g., a simulated environment) that may include simulations of chemical reactions or processes based on a quantum system input (e.g., a molecule) represented at least by the quantum system component 114. In some embodiments, simulations and/or simulation output(s) 170 may include representations of artificial intelligence (AI) vehicles or other objects (e.g., pedestrians, animals, etc.), hardware-in-the-loop (HIL) vehicles or other objects, software-in-the-loop (SIL) vehicles or other objects, and/or person-in-the-loop (PIL) vehicles or other objects. One or more simulation outputs 170 from the global simulation may be presented by the user device 116. The global simulation may be maintained within an engine (e.g., a game engine), or other software development environment, which may include a rendering engine (e.g., for two-dimensional (2D) and/or three-dimensional (3D) graphics), a physics engine (e.g., for collision detection, collision response, etc.), a generative AI model, a large language model, sound, scripting, animation, AI, networking, streaming, memory management, threading, localization support, scene graphs, cinematics, and/or other features. In some embodiments, simulation output(s) 170 may be used for, and/or in conjunction with, generating synthetic training data for training AI models.

The simulation processing component(s) 140 may include any number of CPU(s), GPU(s), QPU(s), quantum computing resources, other hardware accelerators, and/or a combination thereof and other processing resources. In some embodiments, as illustrated in FIG. 1, the simulation processing component(s) 140 may be bifurcated into a classical simulation path 122 and a quantum simulation path 124. In some embodiments, the simulation processing component(s) 140 may comprise the quantum simulation path 124 without a classical simulation path 122.

The classical simulation path 122 may comprise a classical simulator 142 that comprises one or more classical computing components 144 (e.g., CPU(s), GPU(s), and/or other processing units) that execute simulations (which may comprise at least in part a classical circuit or system simulation) based on classical algorithms 141 obtained or derived from the classical system component 112. When the hybrid system representation 110 includes a classical system component 112, the simulation controller 130 applies the one or more classical algorithms 141 to the classical computing component(s) 144 for execution. The classical computing component(s) 144 executes the classical algorithm(s) 141 to generate a classical computing output 160.

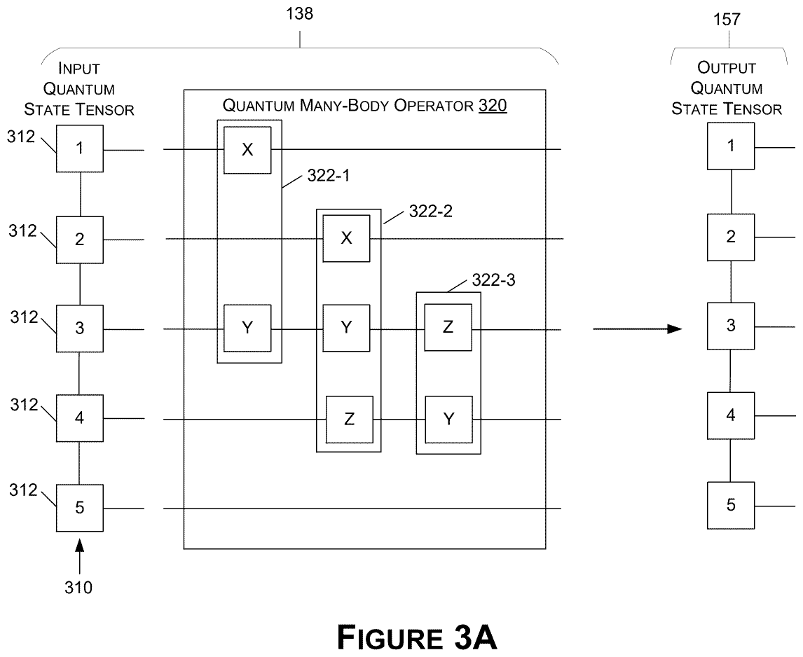

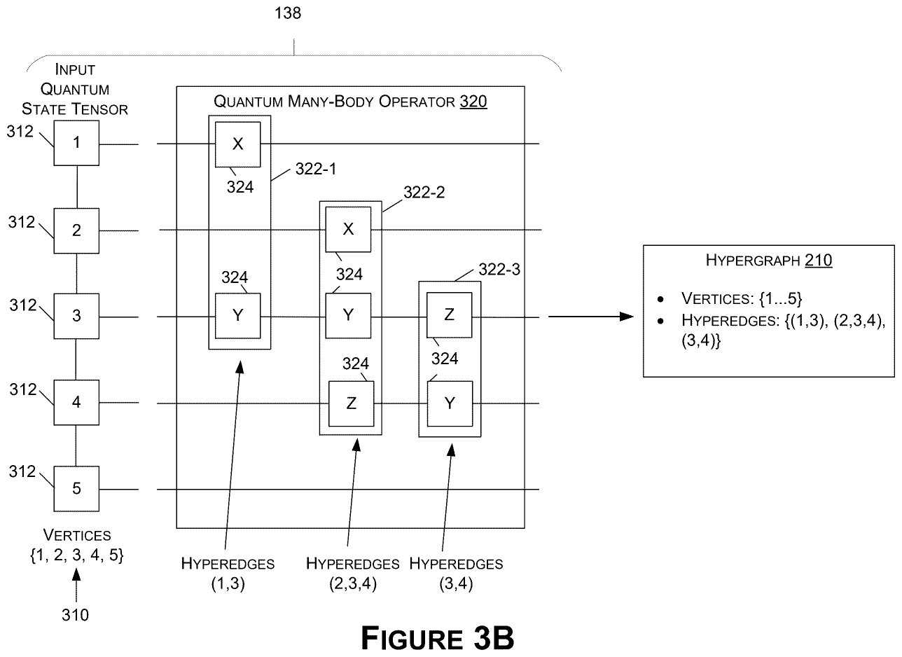

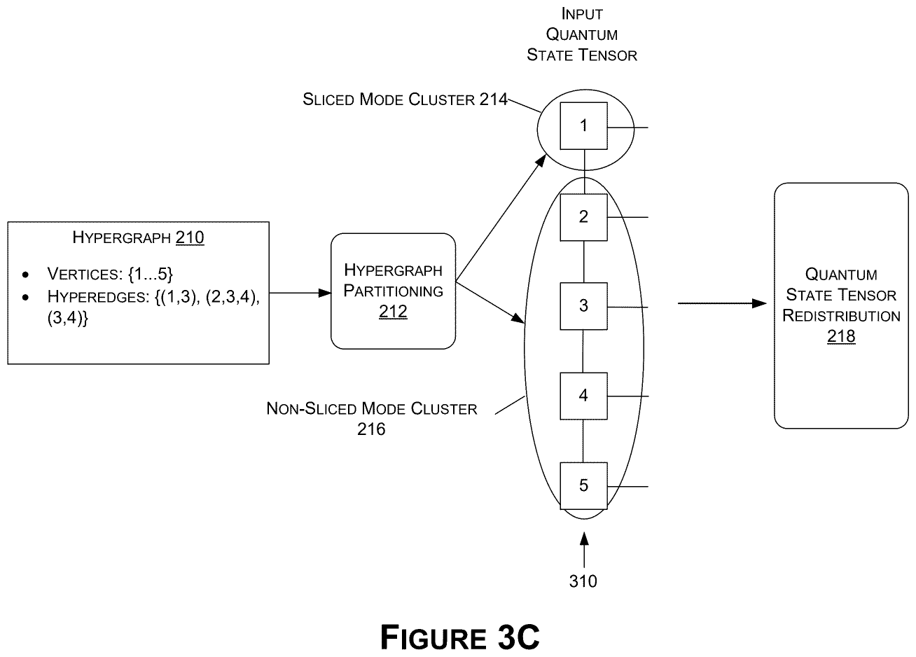

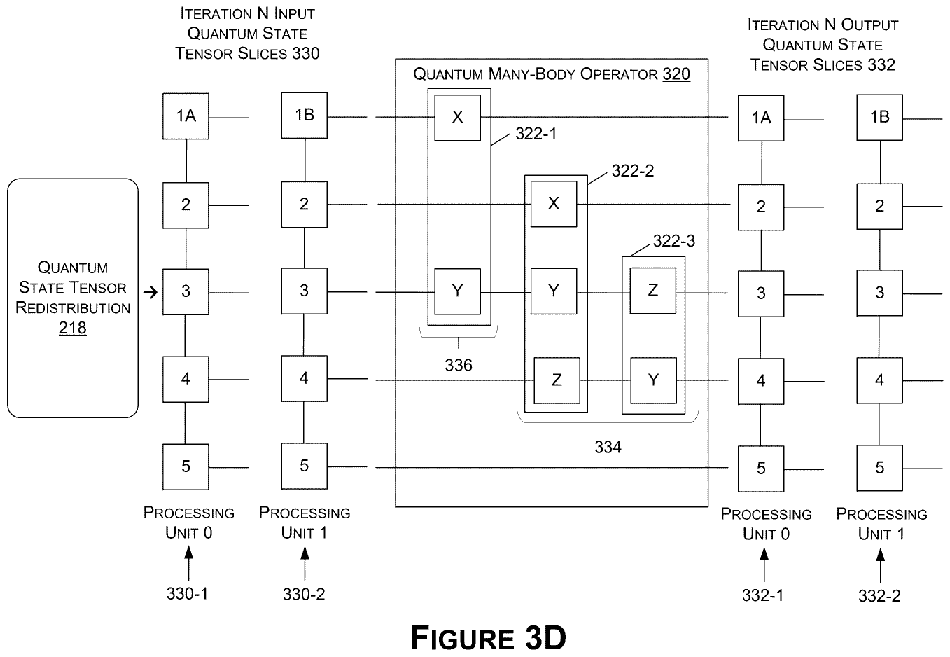

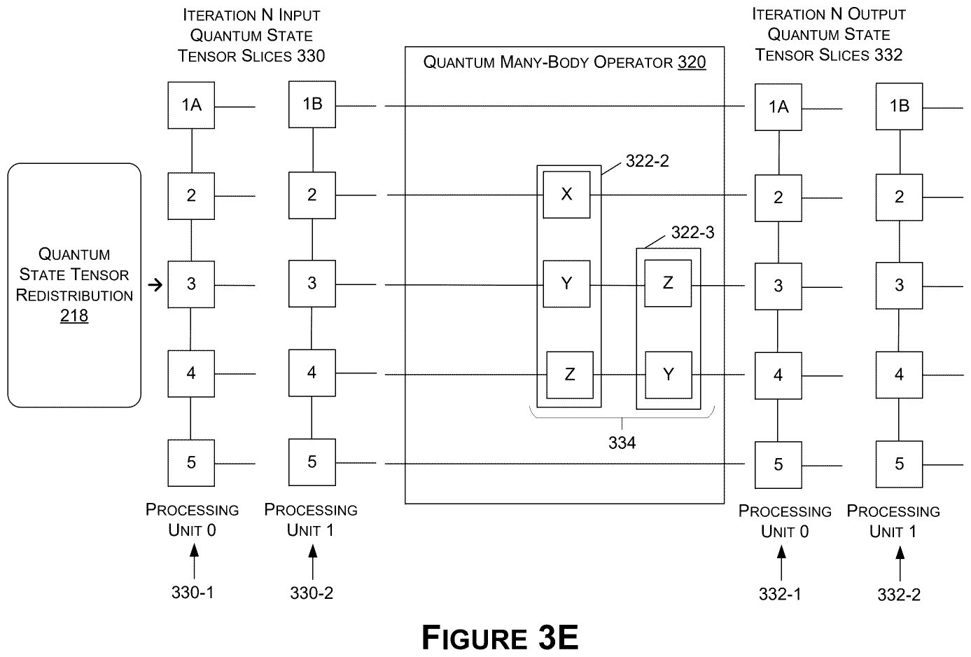

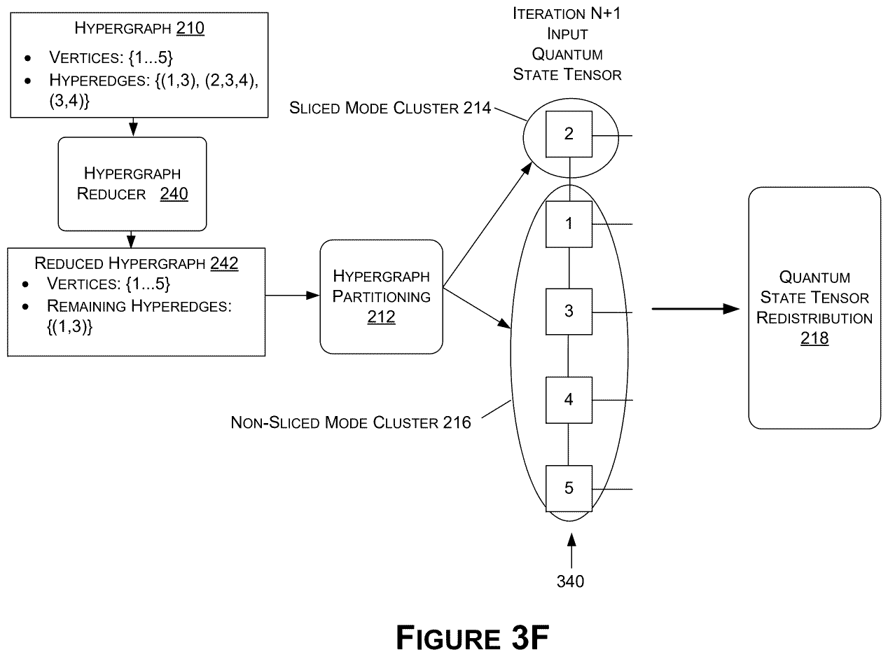

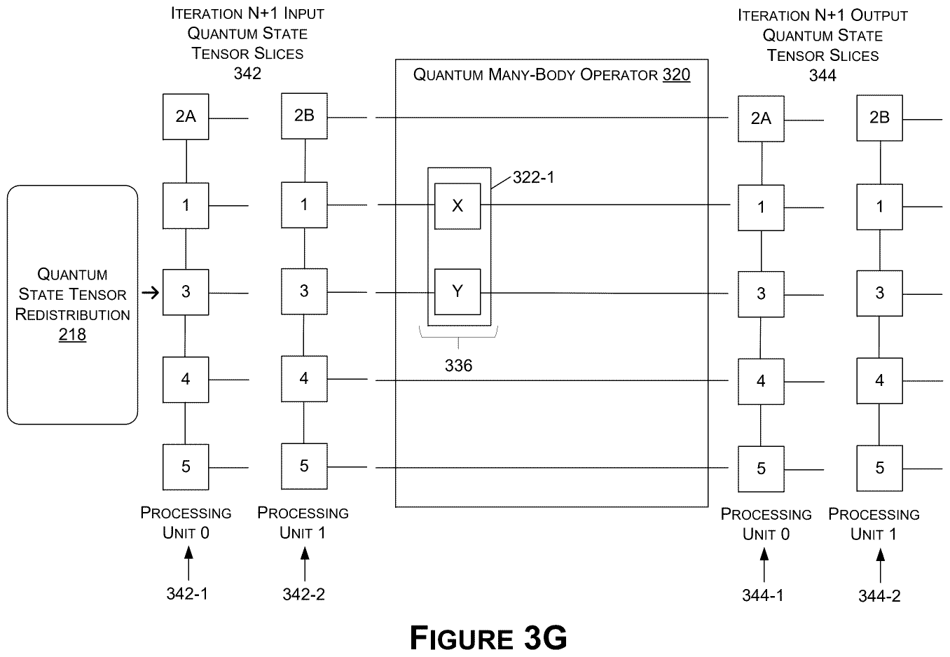

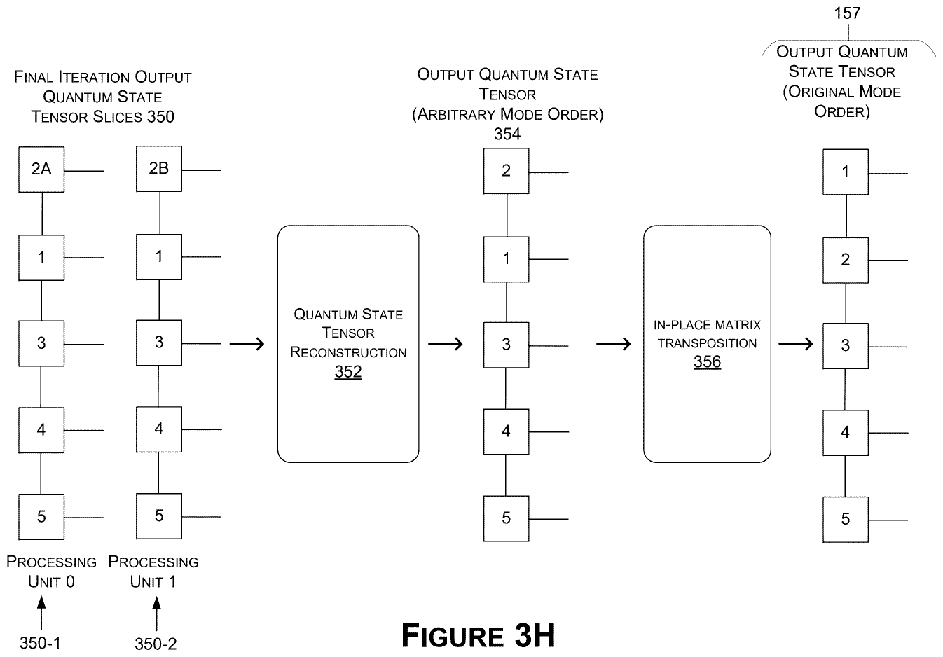

In some embodiments, quantum simulation path 124 may comprise a tensor simulator 150 that may include computing resources to execute quantum system simulations (e.g., one or more simulations of the execution of quantum algorithms on a quantum processor). In some embodiments, tensor simulator 150 may simulate a quantum system-comprising a tensor representation 138 derived from the quantum system component 114. For example, as illustrated by FIG. 3A, the tensor representation 138 of a quantum system may comprise quantum state tensor 310 comprising a plurality of quantum degrees of freedom 312, also referred to herein as modes 312. In the non-limiting example of FIG. 3A, the quantum state tensor 310 is shown as comprising five modes 312. However, in embodiments, a quantum state tensor 310 may comprise any number of modes 312. The tensor representation 138 of the quantum system further comprises a quantum many-body operator 320 that includes one or more elementary operators 322 (shown individually in this example as elementary operators 322-1, 322-2, and 322-3), each of which act on one or more of the modes 312 of the quantum state tensor 310. As discussed herein, simulation of time dynamics of a given quantum system on the quantum system simulation platform 120 to produce quantum simulation results 157 involves the tensor simulator 150 computing the action of the quantum many-body operator 320 (e.g., a quantum Liouvillian operator) on the quantum state tensor 310 representing the quantum state of the given quantum system.

As shown in FIG. 1, in some embodiments, the tensor simulator 150 may comprise a scheduling optimizer 152 and an execution stage 154. The execution stage 154 of the tensor simulator 150 may comprise quantum simulation processing units 151. Quantum simulation processing units 151 comprise computing resources (processing circuitry) that include one or more classical computing components 155 (e.g., CPU(s), GPU(s), or other processing units) and/or one or more quantum computing components 156 (e.g., a QPU, quantum computer, and/or other quantum computing resource) that execute quantum system simulation algorithms based on the tensor representation 138. In some embodiments, quantum simulation processing units 151 may comprise a plurality of individual processing units that operate in parallel to process the tensor representation 138 based on a plurality of quantum state tensor slices distributed across the quantum simulation processing units 151 by the scheduling optimizer 152 based on hypergraph partitioning and quantum state tensor redistribution as described herein. The execution stage 154 may comprise a workspace memory 153, which may function as a buffer for performing inter-processor communication of quantum state tensor slice data between the quantum simulation processing units 151.

The classical computing components 155 and/or quantum computing components 156 may, in some embodiments, be implemented using either shared processing resources or distinct processing resources of the quantum system simulation platform 120. In some embodiments, operations of the scheduling optimizer 152 and/or execution stage 154 described herein may be at least in part performed using the one or more of the classical computing components 155, quantum computing component(s) 156, and/or other processing units of the. quantum system simulation platform 120.

In some embodiments, the quantum simulation result 157 may include one or more of an expectation value, a sampling, a reduced density matrix, a single and/or batched bit-string amplitude, a measurement, and/or other statistical representation of a quantum state of the simulated quantum system. The quantum simulation result 157 may be a representation of at least a component of the state vector (e.g., a final or non-final state) for a quantum system (e.g., quantum system component 114) and/or may represent a resulting state and/or value of one or more modes of the tensor representation 138 input. In some embodiments, the quantum simulation result 157 may be used for performing a quantum state preparation.

In some embodiments, to produce quantum simulation result 157, the tensor simulator 150 may extract a representation of at least a component of a state vector of the quantum system, extract a representation of at least one component of one or more product states of the quantum system, obtain an expectation value of the original quantum system, sample at least one component of one or more product states of the final state, and/or compute a norm of the final state vector. For example, in some embodiments, an expectation value derived from a quantum simulation result 157 may be used as an input to the classical simulator 142, and/or to inform a machine learning algorithm executing on the quantum system simulation platform 120. In some embodiments, the quantum simulation result 157 may be read as an input by the classical simulator 142 and used in the process of computing the classical computing output 160. The simulation output(s) 170 generated by the processing of the hybrid system representation 110 and/or the tensor representation 138 using the quantum system simulation platform 120 may comprise the quantum simulation result 157 and/or the classical computing output 160. In some embodiments, the simulation output(s) 170 may be fed to the user device 116 and/or other systems for review and/or further analysis.

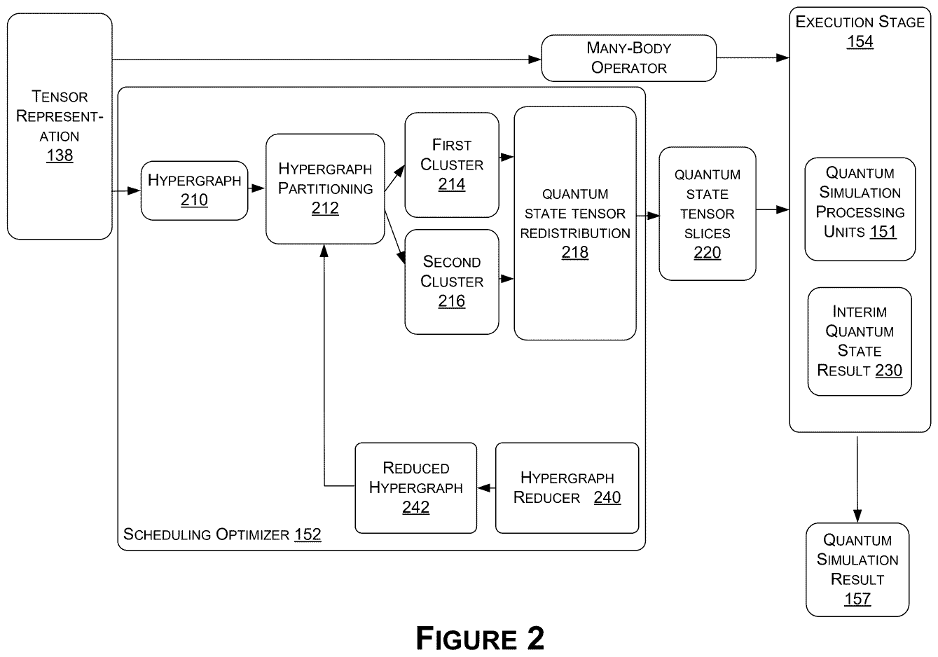

FIG. 2 is a data flow diagram for an example iterative quantum state tensor redistribution process performed by a scheduling optimizer 152, according to some embodiments. As shown in FIG. 2, the scheduling optimizer 152 may receive as input the tensor representation 138 of a quantum system. The tensor representation 138 comprises a quantum state tensor 310 and a quantum many-body operator 320 that acts on the quantum state tensor 310. Based on the tensor representation 138, the scheduling optimizer 152 produces a hypergraph 210. Hypergraph 210 provides the framework used by the scheduling optimizer 152 to identify which combination of the many possible sequences of tensor redistributions provides a solution in a minimal number of such tensor data redistributions across processing units 151. The scheduling optimizer 152 may construct the hypergraph 210 using modes of the quantum state tensor 310 to define vertices of the hypergraph 210, and elementary operators of the quantum many-body operator 320 to define hyperedges of the hypergraph 210. The scheduling optimizer 152 applies the hypergraph 210 to hypergraph partitioning 212 to produce a first cluster 214 and a second cluster 216. Based on the respective first cluster 214 and second cluster 216, the quantum state tensor redistribution 218 may then be performed. The quantum state tensor redistribution 218 permutes and redistributes the quantum state tensor 310 into quantum state tensor slices 220 that include a combination of sliced and/or non-sliced modes according to the partitioning (e.g., the first and second clusters) obtained from the hypergraph partitioning 212. The quantum state tensor slices 220 are input to the execution state where they are distributed across the processing units 151 with individual processing units processing a respective one of the quantum state tensor slices 220. The elementary operators of the quantum many-body operator 320 that are able to fully complete their actions on non-sliced modes of the quantum state tensor 310 (e.g., they do not include actions performed on sliced modes) are computed by the processing units 151. The scheduling optimizer 152 then may modify the hypergraph 210 using the hypergraph reducer 240 to generate a reduced hypergraph 242 by removing hyperedges corresponding to the elementary operators that were applied to the quantum state tensor slices. When there are remaining elementary operators to be applied, the scheduling optimizer 152 may proceed with another iteration by applying hypergraph partitioning 212 to the reduced hypergraph 242. Partial simulation results after the completion of each iteration may be represented by an interim quantum state result 230, which represents the value of a current quantum state tensor as being the end of that iteration, and may be used as the input quantum state tensor for the next iteration, or output as the quantum simulation result 157 after completion of the final iteration.

This iterative distributed simulation process may be explained in greater detail with reference to FIGS. 3A-3H. The scheduling optimizer 152 at each stage identifies operations of the quantum many-body operator that can be applied without operating on sliced modes of the quantum state tensor, and applies those operators. Such operations that only touch non-sliced modes can be applied without incurring inter-processor communication costs. For those remaining operations, a global tensor redistribution is performed in which a different mode of the quantum state tensor is permuted, sliced, and distributed across the processing units. The remaining operators that can be applied to non-sliced modes of the redistributed modes (without communication) are applied, and the iterative process repeats until each of the operators of the quantum many-body operator has been applied.

As previously discussed, FIG. 3A illustrates a tensor representation 138 comprising a quantum state tensor 310 that includes a plurality of modes 312 and a quantum many-body operator 320 that includes one or more elementary operators 322 (shown individually in this example as elementary operators 322-1, 322-2, and 322-3), each of which act on one or more of the modes 312 of the quantum state tensor 310.

As illustrated in FIG. 3B, in some embodiments the hypergraph 210 may be generated by the scheduling optimizer 152 from the tensor representation 138. Hypergraph 210 may comprise a number of vertices defined by and corresponding to the modes 312 of a quantum state tensor 310. Hypergraph 210 may further comprise a plurality of hyperedges defined by and corresponding to the elementary operators 322 of the quantum many-body operator 320. In other words, individual vertices of the hypergraph 210 correspond to respective quantum state tensor modes 312. Individual tensor products 324 of the elementary operators 322 are individually associated with a corresponding hyperedge of the hypergraph 210.

In this non-limiting example of FIG. 3B, a first elementary operator 322-1 comprises individual tensor products 324 acting on modes 1 and 3 so that the scheduling optimizer 152 includes hyperedges for vertices 1 and 3 corresponding to that first elementary operator 322-1. A second elementary operator 322-2 comprises individual tensor products 324 acting on modes 2, 3, and 4 so that the scheduling optimizer 152 further adds to the hypergraph's 210 hyperedges for vertices 2, 3, and 4 corresponding to that second elementary operator 322-2. A third elementary operator 322-3 comprises individual tensor products 324 acting on modes 3 and 4 so that the scheduling optimizer 152 adds to the hypergraph 210 hyperedges for vertices 3 and 4 corresponding to that second elementary operator 322-3. Such a process may continue to construct the hypergraph 210 until each of the elementary operators 322 of the quantum many-body operator 320 are represented by one or more edges attached to one or more vertices of the hypergraph 210.

Referring next to FIG. 3C, in some embodiments the hypergraph 210 may be applied to a hypergraph partitioning 212 function of the scheduling optimizer 152. Hypergraph partitioning 212 performs a clustering process to partition the hypergraph 210 into a first cluster 214 that comprises vertices corresponding to modes of the quantum state tensor 310 that will be shared across the processing units 151 as sliced modes, and a second cluster 216 that comprises vertices corresponding to modes that will be shared across the processing units 151 as whole (non-sliced) modes. In some embodiments, the hypergraph partitioning 212 performs the clustering by performing a minimum-cut graph-based algorithm. The hypergraph partitioning 212 may apply a constraint specifying that the smaller first cluster 214 include at least a minimum number of modes that are sufficient to decompose the quantum state tensor 310 across all processing units 151, and specifying that the number of connections (e.g., the number of hyperedges) connecting the first cluster 214 and second cluster 216 is minimized. Based on performing the minimum cut, the smaller first cluster 214 may indicate which modes should be sliced, and the larger second cluster 216 may indicate which modes do not need to be sliced.

Based on the respective first cluster 214 and second cluster 216, the quantum state tensor redistribution 218 may then be performed on the quantum state tensor 310, as shown in FIG. 3D. The quantum state tensor redistribution 218 permutes and redistributes the quantum state tensor 310 into tensor slices that include a combination of sliced and/or non-sliced modes according to the partitioning obtained from the hypergraph partitioning 212. In FIG. 3D, the quantum state tensor redistribution 218 redistributes the input quantum state tensor 310 into two quantum state tensor slices 330 (shown individually at 330-1 and 330-2). The quantum state tensor slices 330 are shared across processing units 151 (processing unit 0 and processing unit 1, in this example). In this example, mode 1 (included in the smaller first cluster 214) is sliced such that the mode slice 1A of tensor slice 330-1 includes a first set of data (e.g., energy levels) of mode 1, and mode slice 1B of tensor slice 330-2 includes a second set of the remaining data (e.g., energy levels) of mode 1 not included in slice 1A. Output quantum state tensor slices 332 similarly include two quantum state tensor slices 332-1 and 332-2 such that the mode slice 1A of tensor slice 332-1 includes the first set of data (e.g., energy levels) of mode 1, and mode slice 1B of tensor slice 332-2 includes the second set of the data (e.g., energy levels) of mode 1. It should be noted that in some embodiments, the quantum state tensor redistribution 218 may distribute a quantum state tensor 310 as quantum state tensor slices 330 across any number of processing units 151 with an individual processing unit 151 processing a respective one of the quantum state tensor slices 330. Moreover, based on the vertices included in the smaller first cluster 214, the quantum state tensor redistribution 218 may slice one or any plurality of modes across the quantum state tensor slices 330.

For the elementary operators 322-2 and 322-3 shown at 334, the tensor products of these elementary operators may act on full (non-sliced) modes of the quantum state tensor 310, meaning that processing unit 0 and processing unit 1 have full representations of each of the modes that are to be acted on, and those elementary operators 322-2 and 322-3 can be fully applied locally by the respective processing units 151. Because elementary operators 322-2 and 322-3 act on the non-sliced modes (and not on sliced modes), communication between processing unit 0 and processing unit 1 is not needed to fully compute these operations.

However, for the elementary operator 322-1 shown at 336, at least one tensor product would be operating on sliced modes (e.g., 1A and 1B), which means that neither processing unit 0 (processing slice 330-1) nor processing unit 1 (processing slice 330-2) has in its respective memory a full representation of the sliced mode. For that reason, elementary operator 322-1 cannot be fully computed without incurring costly inter-processing unit communication between processing unit 0 and processing unit 1.

Accordingly, as shown in FIG. 3E, when a first iteration (e.g., iteration N) of processing the quantum state tensor representation 138 is executed, the scheduling optimizer 152 may control the execution stage 154 of the tensor simulator 150 to distribute the quantum state tensor slices 330 across the processing units 151 and apply the set 334 of elementary operators 322-2 and 322-3, which act on the non-sliced modes (and not the sliced modes) of the quantum state tensor slices 330. The resulting output quantum state tensor slices (e.g., slices 332-1 and 332-2) together represent the full action of those elementary operators 322-2 and 322-3 on the modes of the input quantum state tensor slices 330.

Moreover, because the actions of elementary operators 322-2 and 322-3 have now been obtained, the scheduling optimizer 152 may update the hypergraph 210 to account for their application. More specifically, in some embodiments, as shown in FIG. 3F, to prepare for the next simulation iteration (e.g., iteration N+1), the scheduling optimizer 152 may modify the hypergraph 210 using the hypergraph reducer 240 to generate a reduced hypergraph 242. The hypergraph reducer 240 may modify the hypergraph 210 by removing hyperedges corresponding to the elementary operators 322-2 and 322-3 that were applied in the most recent iteration such that a reduced hypergraph 242 comprises edges corresponding to those elementary operators 322 (e.g., elementary operators 322-1) of the quantum many-body operator 320 that have yet to act on the quantum state tensor 310. The next iteration (e.g., iteration N+1) of processing the tensor representation 138 may then proceed by applying hypergraph partitioning 212 to the reduced hypergraph 242, to once again produce a first cluster 214 corresponding to a set of one or more modes to be shared across the processing units 151 as sliced modes, and a second cluster 216 corresponding to a set of one or more modes that will not be sliced, but instead shared across the processing units 151 as whole (non-sliced) modes.

As in the prior iteration, based on the vertices included in the respective first cluster 214 and second cluster 216, a quantum state tensor redistribution 218 may be performed on the quantum state tensor 340. The quantum state tensor redistribution 218 permutes and redistributes the quantum state tensor 340 into quantum state tensor slices 342, as shown in FIG. 3G, comprising sliced and non-sliced modes determined by the hypergraph partitioning 212.

To perform the next iteration (e.g., N+1), the quantum state tensor redistribution 218 redistributes the input quantum state tensor 340 into two quantum state tensor slices 342 where quantum state tensor slice 342-1 is distributed to processing unit 0, and quantum state tensor slice 342-1 is distributed to processing unit 1. For this iteration, mode 2 of the input quantum state tensor 340 is partitioned into the smaller first cluster 214, and accordingly mode 2 is permuted and sliced between quantum state tensor slices 342-1 and 342-2 such that the mode slice 2A of tensor slice 342-1 includes a first set of data (e.g., energy levels) of mode 2, and mode slice 2B of tensor slice 342-2 includes the second set of the data (e.g., energy levels) of mode 2. For this iteration, output quantum state tensor slices 344 similarly include two quantum state tensor slices 344-1 and 344-2 such that the mode slice 2A of tensor slice 344-1 includes a first set of data (e.g., energy levels) of mode 2, and mode slice 2B of tensor slice 344-2 includes the second set of the data (e.g., energy levels) of mode 2.

In the reconfigured mode distribution pattern shown in FIG. 3G, the product tensors of the elementary operator 322-1 may not be fully applied to non-sliced modes of the quantum state tensor slices 342-1 and 342-2. Processing unit 0 and processing unit 1 have full representations of each of the modes that are to be acted on, and elementary operators 322-1 can be applied locally by the respective processing units. The scheduling optimizer 152 may control the execution stage 154 of the tensor simulator 150 to share the quantum state tensor slices 342-1 and 342-2 across the processing unit 0 and processing unit 1 and apply the elementary operator 322-1, which in this iteration will act on the non-sliced modes (and not the sliced modes) of the quantum state tensor slices 342. The resulting output quantum state tensor slices 344 (e.g., slices 344-1 and 344-2) together represent the full action of elementary operator 322-1 on the modes of the input quantum state tensor slices 342.

In some embodiments, partial simulation results after the completion of each iteration may be represented by an interim quantum state result 230, which represents the value of a current quantum state tensor as of the end of that iteration, and may be used as the input quantum state tensor for the next iteration, or output as the quantum simulation result 157 after completion of the final iteration.

As illustrated in FIG. 3H, after completion of the final iteration, the final iteration of output quantum state tensor slices 350 (e.g., slices 350-1 and 350-2) may be recombined (e.g., de-sliced by quantum state tensor reconstruction 352) into an output quantum state tensor 354—which represents the full application of the quantum many-body operator 320 onto the original quantum state tensor 310, and thus is a representation of a simulation of the quantum system represented by the tensor representation 138. In some embodiments, the modes of output quantum state tensor 354 may be arbitrarily reordered, depending on the various mode reordering performed by performing quantum state tensor redistribution 218 within each processing iteration. In some embodiments, the quantum simulation result 157 may be generated based on such a reordered output quantum state tensor 354. In some embodiments, the reordered output quantum state tensor 354 may be reordered (e.g., using an in-place matrix transposition 356) back into the mode order of the original quantum state tensor 310 to produce the quantum simulation result 157.

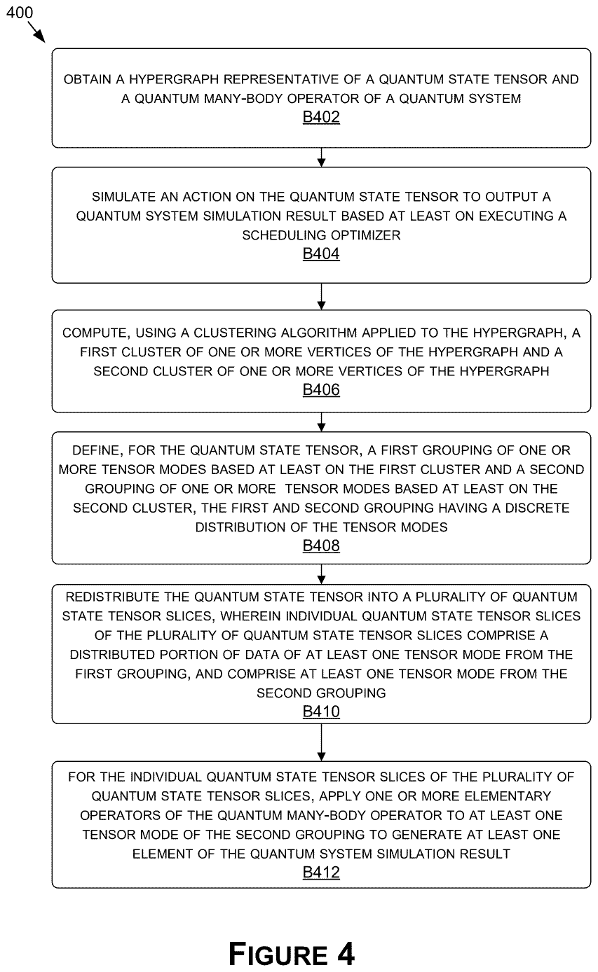

Now referring to FIG. 4, FIG. 4 is a flow diagram showing a method 400 for simulating a quantum system using an optimized tensor mode redistribution schedule, in accordance with some embodiments of the present disclosure. The features and elements described herein with respect to the method 400 of FIG. 4 may be used in conjunction with, in combination with, or substituted for elements of any of the other embodiments discussed herein and vice versa. Further, the functions, structures, and other descriptions of elements for embodiments described in FIG. 4 may apply to like or similarly named or described elements across any of the figures and/or embodiments described herein and vice versa.

Each block of method 400, described herein, comprises a computing process that may be performed using any combination of hardware, firmware, and/or software. For instance, various functions may be carried out by one or more processors comprising processing circuitry and executing instructions stored in memory. The methods may additionally, or alternatively, be embodied as computer-usable instructions stored on computer storage media. The methods may be provided by a standalone application, a service or hosted service (standalone or in combination with another hosted service), or a plug-in to another product, to name a few. In addition, method 400 is described, by way of example, with respect to the example quantum simulation environment 100 of FIG. 1. However, these methods may additionally or alternatively be executed by any one system, or any combination of systems, including, but not limited to, those described herein.

In some embodiments, method 400 may generally be directed to generating an output comprising a simulation of a quantum system based at least on, iteratively: computing, based at least on a hypergraph representation, a first cluster and a second cluster, the hypergraph representation comprising a tensor representation of the quantum system and based at least on a quantum state tensor and a quantum many-body operator; redistributing the quantum state tensor into a plurality of quantum state tensor slices, individually comprising a distributed portion of data of one or more sliced tensor modes determined from the first cluster, and one or more non-sliced tensor modes determined from the second cluster; applying one or more elementary operators of the quantum many-body operator (and/or one or more products of the one or more elementary operators) to the one or more non-sliced tensor modes of individual quantum state tensor slices of the plurality of quantum state tensor slices to generate at least a component of the simulation of the quantum system; and removing from the hypergraph one or more hyperedges corresponding to the one or more elementary operators (and/or one or more products of the one or more elementary operators) to produce a reduced hypergraph to perform at least one additional iteration based on the reduced hypergraph.

The method 400, at block B402, includes obtaining a hypergraph representative of a quantum state tensor and a quantum many-body operator of a quantum system. In some embodiments, the quantum many-body operator may comprise at least one of: a quantum Liouvillian operator, a system Hamiltonian operator, an electro-magnetic interaction Hamiltonian operator, and/or a system-environment interaction operator. As explained herein, a hypergraph constructed from the quantum many-body operator may provide the framework used by the scheduling optimizer to identify which combination of the many possible sequences of tensor redistributions provides a solution in a minimal number of such tensor data redistributions across processing units. In some embodiments, a scheduling optimizer 152 as shown in FIG. 1 may construct a hypergraph wherein each of the vertices of the hypergraph correspond to a mode of the quantum state tensor. The scheduling optimizer may sequence through one or more (e.g., each) individual operator or operator product of the quantum many-body operator to identify which modes of the quantum state tensor are acted on by that operator or operator product. For example, if a first operator acts on modes 1 and 3 of the quantum state tensor, then the scheduling optimizer adds a hyperedge to vertices 1 and 3 of the hypergraph. If a second operator acts on modes 2, 3, and 4 of the quantum state tensor, then the scheduling optimizer adds a hyperedge to vertices 2, 3, and 4 of the hypergraph. The scheduling optimizer sequences through the operator products of the quantum many-body operator until all corresponding hyperedges are added to the vertices of the hypergraph for each operator or operator product constituting the quantum many-body operator.

The method 400, at block B404, includes simulating an action on the quantum state tensor to output a quantum system simulation result based at least on executing a scheduling optimizer. As shown in FIG. 1, in some embodiments, the tensor simulator 150 may comprise a scheduling optimizer 152 and an execution stage 154. The execution stage 154 of the tensor simulator 150 may comprise quantum simulation processing units 151. In some embodiments, quantum simulation processing units 151 may comprise a plurality of individual processing units. The quantum simulation processing units 151 may comprise a plurality of individual processing units that operate in parallel to process the tensor representation 138 based on a plurality of quantum state tensor slices distributed across the quantum simulation processing units 151 by the scheduling optimizer 152.

The scheduling optimizer may perform at least one simulation iteration to perform the operations described in blocks B406 to B412.

The method 400, at block B406, includes computing, using a clustering algorithm applied to the hypergraph, a first cluster of one or more vertices of the hypergraph and a second cluster of one or more vertices of the hypergraph. For example, hypergraph partitioning 212 may perform a clustering process to partition the hypergraph 210 into a first cluster 214 and a second cluster 216. The first cluster 214 comprises vertices corresponding to modes of the quantum state tensor 310 that will be distributed across the processing units 151 as sliced modes. The second cluster 216 comprises vertices corresponding to modes that will be shared across the processing units 151 as whole (non-sliced) modes. In some embodiments, the hypergraph partitioning 212 computes the clustering by performing a minimum-cut graph-based algorithm. The hypergraph partitioning 212 may apply a constraint specifying that the smaller first cluster 214 include at least a minimum number of modes which are sufficient to decompose the quantum state tensor 310 across all processing units 151, and specifying that the number of connections (e.g., the number of hyperedges) connecting the first cluster 214 and second cluster 216 is minimized. Based on performing the minimum cut, the smaller first cluster 214 may indicate which modes should be sliced, and the larger second cluster 216 may indicate which modes do not need to be sliced.

The method 400, at block B408, includes defining, for the quantum state tensor, a first grouping of one or more tensor modes based at least on the first cluster and a second grouping of one or more tensor modes based at least on the second cluster, the first and second grouping having a discrete distribution of the tensor modes. In some embodiments, the hypergraph partitioning 212 performs the clustering by performing a minimum-cut graph-based algorithm. The hypergraph partitioning 212 may apply a constraint specifying that the smaller first cluster 214 include at least a minimum number of modes that are sufficient to decompose the quantum state tensor 310 across all processing units 151, and specifying that the number of connections (e.g., the number of hyperedges) connecting the first cluster 214 and second cluster 216 is minimized. Based on performing the minimum cut, the smaller first cluster 214 may indicate which modes should be sliced, and the larger second cluster 216 may indicate which modes do not need to be sliced. Based on the respective first cluster 214 and second cluster 216, the quantum state tensor redistribution 218 may then be performed on the quantum state tensor 310.

The method 400, at block B410, includes redistributing the quantum state tensor into a plurality of quantum state tensor slices, wherein individual quantum state tensor slices of the plurality of quantum state tensor slices comprise a distributed portion of data of at least one tensor mode from the first grouping, and comprise at least one tensor mode from the second grouping. Redistributing may include permuting a mode order of the quantum state tensor based at least on at least one tensor mode from the first grouping and at least one tensor mode of the second grouping. For example, permuting may be based at least on one or more sliced tensor modes and one or more non-sliced tensor modes. The method may redistribute the quantum state tensor into the plurality of quantum state tensor slices, wherein the individual quantum state tensor slices of the plurality of quantum state tensor slices are respectively distributed to processing units of a quantum simulation platform comprising a plurality of processing units, and execute an inter-processing unit communication exchange between the plurality of processing units to exchange quantum state tensor mode data prior to the application of the one or more elementary operators of the quantum many-body operator (and/or one or more products of the one or more elementary operators) to the one or more non-sliced tensor modes. The execution stage 154 may comprise a workspace memory 153, which may function as a buffer for performing inter-processor communication of quantum state tensor slice data between the quantum simulation processing units 151. For example, quantum state tensor redistribution 218 may permute and redistribute the quantum state tensor 310 into tensor slices that include a combination of sliced and/or non-sliced modes according to the partitioning obtained from the hypergraph partitioning 212. In some embodiments, the inter-processing unit communication exchange is performed as an out-of-place distributed tensor redistribution based at least on a workspace buffer memory that is of at least the same total size as the quantum state tensor to perform a transfer of quantum state tensor data. In some embodiments, the inter-processing unit communication exchange is performed using a memory segmentation based at least on sub-slices of a first tensor mode from the second grouping (e.g., a non-sliced mode) that is not sliced in both the initial tensor input to a simulation iteration and the target tensor output from the simulation iteration, and a workspace buffer memory that is of a smaller total size than the quantum state tensor. An inter-processing unit communication exchange may be performed based at least on an in-place matrix transposition.

The method 400, at block B412, includes—for the individual quantum state tensor slices of the plurality of quantum state tensor slices—applying one or more elementary operators of the quantum many-body operator to at least one tensor mode of the second grouping to generate at least one element of the quantum system simulation result. As explained above, simulation of time dynamics of a given quantum system on a classical computer involves computing the action of a quantum many-body operator (e.g., a quantum Liouvillian operator) on the quantum state tensor representing the quantum state of the given quantum system. The scheduling optimizer creates a schedule of a minimal number of tensor redistributions based on the hypergraph and in an iterative process, at each iteration identifies operator terms (elementary operators) of the quantum many-body operator that can be applied without operating on sliced modes of the quantum state tensor, and applies those operators. The one or more elementary operators comprise, for example, at least one of: a quantum spin/Pauli operator, or a second-quantized operator.

After application of the elementary operators of the quantum many-body operator that act on the non-sliced modes, hyperedges corresponding to the applied elementary operators are removed from the hypergraph to produce a reduced hypergraph comprising those elementary operators that are yet to have acted on the quantum state tensor. The method may remove from the hypergraph one or more hyperedges corresponding to the one or more elementary operators to produce a reduced hypergraph. When the reduced hypergraph comprises at least one hyperedge corresponding to an elementary operator of the quantum many-body operator (or a product of the elementary operator) that has not been applied to the plurality of quantum state tensor slices, the method may perform at least one additional simulation iteration based on the reduced hypergraph. That is, the reduced hypergraph operates as the seed hypergraph for performing the next iteration of the method (e.g., clustering, permuting, quantum state tensor redistribution, and application of elementary operators as just described). After each iteration, the hypergraph is further reduced in size as hyperedges as the already applied elementary operators are removed. Partial simulation results after the completion of each iteration may be represented by an interim quantum state result 230, which represents the value of a current quantum state tensor as of the end of that iteration, and may be used as the input quantum state tensor for the next iteration, or output as the quantum simulation result 157 after completion of the final iteration.

In some embodiments, the systems and methods described herein may be performed within, or in conjunction with, a simulation environment (e.g., NVIDIA's cuQuantum) using simulated data (e.g., produced by quantum circuit simulations). For example, simulated quantum results data may be generated and used to control agent operations associated with a virtual machine within a simulation environment. These simulated operations may be used to test performance of the underlying algorithms, systems, and/or processes prior to deploying them in the real world. In some instances, the simulation may be used to generate synthetic training data—e.g., training data including regions of interest and/or subregions of interest from within the simulation. In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, based on quantum simulation results, a simulation environment and/or one or more objects, features, or components thereof may be generated or managed within a three-dimensional (3D) content collaboration platform (e.g., NVIDIA's Omniverse) for industrial digitalization, generative physical AI, and/or other use cases, applications, or services. For example, the content collaboration platform or system may include a system for using or developing a universal scene descriptor (USD) (e.g., OpenUSD) data for managing objects, features, scenes, etc., within a simulated environment, digital environment, etc. The platform may include real physics simulation, such as using NVIDIA's PhysX software development kit (SDK), in order to simulate real physics and physical, quantum mechanical, and/or quantum chemistry interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models-such as one or more large language models (LLMs) and/or one or more vision language models (VLMs), systems for performing light transport simulation, systems for performing collaborative content creation for 3D assets, systems implemented at least partially using cloud computing resources, and/or other types of systems.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

### Example Computing Device

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof. In some embodiments, one or more functions of the quantum system simulation platform 120 and/or the tensor simulator 150 may be performed using computing device(s) 500. For example, one or more of the quantum simulation processing units 151 may comprise processing circuitry such as one or more of CPUs 506, GPUs 508 and/or logic units 520.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). As such, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media. In some embodiments, workspace memory 153 may be implemented using memory 504.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. For example, simulation of the quantum system represented by tensor representation 138 may be executed on the GPU(s) 508. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link) to form the quantum simulation processing units 151. The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

In some embodiments, one or more functions of the quantum system simulation platform 120 and/or scheduling optimizer 152 may be performed at least in part using one or more of the CPU(s) 506, GPU(s) 508 and/or logic unit(s) 520.

The communication interface 510 may include one or more receivers, transmitters, and/or transceivers that allow the computing device 500 to communicate with other computing devices via an electronic communication network, included wired and/or wireless communications. The communication interface 510 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may allow the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that allow detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to allow the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### Example Data Center

FIG. 6 illustrates an example data center 600 that may be used in at least one embodiments of the present disclosure. The data center 600 may include a data center infrastructure layer 610, a framework layer 620, a software layer 630, and/or an application layer 640. In some embodiments, one or more functions of the quantum system simulation platform 120, tensor simulator 150, and/or scheduling optimizer 152 may be performed at least in part using data center 600.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-616(N) may include one or more virtual components, such as vGPUs, vCPUs, and/or the like, and/or one or more of the node C.R.s 616(1)-616(N) may correspond to a virtual machine (VM). In some embodiments, on or more functions of the quantum system simulation platform 120, tensor simulator 150, and/or scheduling optimizer 152 may be performed at least in part using one or more of the C.R.s 616(1)-616(N).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may use distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In some embodiments, on or more functions of the quantum system simulation platform 120, tensor simulator 150, and/or scheduling optimizer 152 may be performed at least in part using executed code based on application(s) 642 and/or software 632.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
obtain a hypergraph representative of a quantum state tensor and a quantum many-body operator of a quantum system; and
simulate an action on the quantum state tensor to output a quantum system simulation result based at least on executing a scheduling optimizer to perform at least one simulation iteration to:
compute, using a clustering algorithm applied to the hypergraph, a first cluster of one or more vertices of the hypergraph and a second cluster of one or more vertices of the hypergraph;
define, for the quantum state tensor, a first grouping of one or more tensor modes based at least on the first cluster and a second grouping of one or more tensor modes based at least on the second cluster, the first and second grouping having a discrete distribution of the tensor modes;
redistribute the quantum state tensor into a plurality of quantum state tensor slices, wherein individual quantum state tensor slices of the plurality of quantum state tensor slices comprise a distributed portion of data of at least one tensor mode from the first grouping, and comprise at least one tensor mode from the second grouping; and
for the individual quantum state tensor slices of the plurality of quantum state tensor slices, apply one or more elementary operators of the quantum many-body operator to at least one tensor mode of the second grouping to generate at least one element of the quantum system simulation result.

2. The one or more processors of claim 1, wherein the processing circuitry is further to:
remove from the hypergraph one or more hyperedges corresponding to the one or more elementary operators, or one or more products of the one or more elementary operators, to produce a reduced hypergraph; and
when the reduced hypergraph comprises at least one hyperedge corresponding to an elementary operator of the quantum many-body operator or a product of the elementary operator, that has not been applied to the plurality of quantum state tensor slices, perform at least one additional simulation iteration based on the reduced hypergraph.

3. The one or more processors of claim 1, wherein the processing circuitry is further to:
permute an ordering of the quantum state tensor based at least on at least one tensor mode from the first grouping and at least one tensor mode of the second grouping.

4. The one or more processors of claim 1, wherein the processing circuitry is further to:
compute the first cluster and the second cluster using the clustering algorithm based at least on a minimum-cut graph algorithm.

5. The one or more processors of claim 1, wherein the one or more elementary operators comprise at least one of: a quantum spin/Pauli operator, or a second-quantized operator.

6. The one or more processors of claim 1, wherein the processing circuitry is further to:
redistribute the quantum state tensor into the plurality of quantum state tensor slices, wherein the individual quantum state tensor slices of the plurality of quantum state tensor slices are respectively distributed to processing units of a quantum simulation platform comprising a plurality of processing units; and
execute an inter-processing unit communication exchange between the plurality of processing units to exchange quantum state tensor mode data prior to the application of the one or more elementary operators of the quantum many-body operator, or one or more products of the one or more elementary operators, to the one or more non-sliced tensor modes.

7. The one or more processors of claim 6, wherein the inter-processing unit communication exchange is performed as an out-of-place distributed tensor redistribution based at least on a workspace buffer memory that is of at least the same total size as the quantum state tensor to perform a transfer of the quantum state tensor mode data.

8. The one or more processors of claim 6, wherein the inter-processing unit communication exchange is performed using a memory segmentation based at least on sub-slices of a first tensor mode from the second grouping that is not sliced in both an initial tensor input to a simulation iteration and a target tensor output from the simulation iteration, and a workspace buffer memory that is of a smaller total size than the quantum state tensor.

9. The one or more processors of claim 8, wherein the inter-processing unit communication exchange is based at least on an in-place matrix transposition.

10. The one or more processors of claim 1, wherein the quantum many-body operator comprises at least one of: a quantum Liouvillian operator, a system Hamiltonian operator, an electro-magnetic interaction Hamiltonian operator, or a system-environment interaction operator.

11. The one or more processors of claim 1, wherein the processing circuitry is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for generating or presenting at least one of virtual reality content, augmented reality content, or mixed reality content;
a system for performing deep learning operations;
a system implemented using an edge device;
a system implemented using a robot;
a system for performing conversational artificial intelligence (AI) operations;
a system implementing one or more language models;
a system implementing one or more large language models (LLMs);
a system implementing one or more vision language models (VLMs);
a system implementing one or more multi-modal language models;
a system for performing generative AI operations;
a system for generating synthetic data;
a system incorporating one or more virtual machines (VMs);
a system implemented at least partially in a data center;
a system implemented at least partially using cloud computing resources;
a system implemented at least partially using quantum computing resources;
a system utilizing a Quantum Processing Unit (QPU);
a system for performing a state preparation;
a system for simulating a quantum system;
a system for compiling a quantum circuit;
a system for executing a quantum circuit;
a system for measuring a quantum state; or
a system for measuring a state of a qubit or qubits.

12. A system comprising one or more processors to:
compute, using a clustering algorithm applied to a hypergraph, a first cluster comprising one or more first vertices of the hypergraph and a second cluster comprising one or more second vertices of the hypergraph;
redistribute a quantum state tensor into a plurality of quantum state tensor slices, wherein individual quantum state tensor slices of the plurality of quantum state tensor slices comprise a distributed portion of data of one or more sliced tensor modes corresponding to the first cluster, and comprise one or more non-sliced tensor modes corresponding to the second cluster; and
apply one or more elementary operators of a quantum many-body operator to the one or more non-sliced tensor modes of the individual quantum state tensor slices of the plurality of quantum state tensor slices to generate at least a component of a quantum system simulation result for a quantum system.

13. The system of claim 12, wherein the one or more processors are further to:
generate the hypergraph based at least on the quantum state tensor and the quantum many-body operator of the quantum system.

14. The system of claim 12, wherein the one or more processors are further to:
remove from the hypergraph one or more hyperedges corresponding to the one or more elementary operators, or one or more products of the one or more elementary operators) to produce a reduced hypergraph; and
when the reduced hypergraph comprises at least one hyperedge corresponding to an elementary operator or a product of the elementary operator, of the quantum many-body operator that has not been applied to the plurality of quantum state tensor slices, perform at least one additional simulation iteration based on the reduced hypergraph.

15. The system of claim 12, wherein the one or more processors are further to:
compute the first cluster and the second cluster using the clustering algorithm based at least on a minimum-cut graph algorithm.

16. The system of claim 12, wherein the one or more processors are further to:
permute an ordering of the quantum state tensor based at least on the one or more sliced tensor modes and the one or more non-sliced tensor modes.

17. The system of claim 12, wherein the one or more processors are further to:
redistribute the quantum state tensor into the plurality of quantum state tensor slices, wherein the individual quantum state tensor slices of the plurality of quantum state tensor slices are respectively distributed to processing units of a quantum simulation platform comprising a plurality of processing units; and
execute an inter-processing unit communication between the plurality of processing units to exchange quantum state tensor data prior to the application of the one or more elementary operators of the quantum many-body operator to the one or more non-sliced tensor modes.

18. The one or more processors of claim 17, wherein the one or more processors are further to selectively, based at least on a determination of available processing resources:
perform the inter-processing unit communication to exchange quantum state tensor mode data using a workspace buffer memory that is of at least the same total size as the quantum state tensor; or
perform the inter-processing unit communication to exchange quantum state tensor mode data using a memory segmentation based at least on sub-slices of a first non-sliced mode that is not sliced in both an initial tensor input to a simulation iteration and a target tensor output from the simulation iteration, and wherein the workspace buffer memory is of a smaller total size than the quantum state tensor.

19. The system of claim 12, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for generating or presenting at least one of virtual reality content, augmented reality content, or mixed reality content;
a system for performing deep learning operations;
a system implemented using an edge device;
a system implemented using a robot;
a system for performing conversational artificial intelligence (AI) operations;
a system implementing one or more language models;
a system implementing one or more large language models (LLMs);
a system implementing one or more vision language models (VLMs);
a system implementing one or more multi-modal language models;
a system for performing generative AI operations;
a system for generating synthetic data;
a system incorporating one or more virtual machines (VMs);
a system implemented at least partially in a data center;
a system implemented at least partially using cloud computing resources;
a system implemented at least partially using quantum computing resources;
a system utilizing a Quantum Processing Unit (QPU);
a system for performing a state preparation;
a system for simulating a quantum system;
a system for compiling a quantum circuit;
a system for executing a quantum circuit;
a system for measuring a quantum state; or
a system for measuring a state of a qubit or qubits.

20. A method comprising:
generating an output comprising a simulation of a quantum system based at least on iteratively:
computing, based at least on a hypergraph representation, a first cluster and a second cluster, the hypergraph representation comprising a tensor representation of the quantum system and based at least on a quantum state tensor and a quantum many-body operator;
redistributing the quantum state tensor into a plurality of quantum state tensor slices, individually comprising a distributed portion of data of one or more sliced tensor modes determined from the first cluster, and one or more non-sliced tensor modes determined from the second cluster;
applying one or more elementary operators, or one or more products of the one or more elementary operators, of the quantum many-body operator to the one or more non-sliced tensor modes of individual quantum state tensor slices of the plurality of quantum state tensor slices to generate at least a component of the simulation of the quantum system; and
removing from the hypergraph one or more hyperedges corresponding to the one or more elementary operators, or one or more products of the one or more elementary operators, to produce a reduced hypergraph to perform at least one additional iteration based on the reduced hypergraph.
